(19) United States
(12) Patent Application Publication
(10) Pub. No.: US 2022/0044298 A1
(43) Pub. Date: Feb. 10, 2022

(54) Method and Apparatus for Extracting Product Attributes from Packaging

(71) Applicant: Foodspace Technology, LLC, New York, NY (US)

(72) Inventors: Ayodele Oshinaike, New York, NY (US); Daniel Yaghsizian, Wallingford, CT (US); Daniel DeMillard, Aurora, CO (US)

(21) Appl. No.: 17/444,536

(22) Filed: Aug. 5, 2021

Related U.S. Application Data
(60) Provisional application No. 63/061,606, filed on Aug. 5, 2020.

(51) Int. Cl. G06Q 30/06; G06F 16/953

(52) U.S. Cl. CPC G06Q 30/0627; G06F 16/953

(57) ABSTRACT

A computing system and database analyses product images to determine product attributes and populate the database. Candidate product information is identified within an image of product packaging of a product. A model created by machine learning is applied to the candidate product information to discern indicators of product attributes from indicators of non-product attributes of the candidate product information. Individual indicators are extracted from the indicators of product attributes. In response to a determination that additional confidence is needed for a given individual indicator, a rule is applied to identify unique product information from the given individual indicator. A taxonomy is then applied to the product attributes based on representations of the individual indicators to generate categorized product attributes representing the product. The database is populated with representations of the categorized product attributes.

### RELATED APPLICATION

This application claims the benefit of U.S. Provisional Application No. 63/061,606, filed on Aug. 5, 2020. The entire teachings of the above application are incorporated herein by reference.

### BACKGROUND

The consumer packaged goods (CPG) industry encompasses a vast array of name brand products that are enjoyed across the world, generating billions of dollars (USD) in sales. As sales continue to migrate to online environments, particularly in the sale of grocery store products, it is increasingly important to accurately convey product information to consumers who cannot view those products in person. It is also essential for name brand products to build trust through transparency with accurate and consistent product data made available to consumers.

Yet, across conventional online product listings, data inconsistencies and errors are common. Digital information is typically managed by a myriad of different suppliers, agencies, providers in several different systems, formats, and taxonomies. This lack of centralization, standardization, and synchronization leads to inaccurate and incomplete data as product information is updated and shared. As a result, retail ecommerce platforms may face a sub-optimal customer search, a lack of discoverability for new brands and products, and poor ecommerce shopping experience for consumers.

### SUMMARY

Example embodiments include a computer-implemented method of populating a database with product information. Candidate product information may be identified within an image of product packaging of a product. A model created by machine learning may be applied to the candidate product information to discern indicators of product attributes from indicators of non-product attributes of the candidate product information. Individual indicators may be extracted from the indicators of product attributes. In response to a determination that additional confidence is needed for a given individual indicator, a rule may be applied to identify unique product information from the given individual indicator. A taxonomy may then be applied to the product attributes based on representations of the individual indicators to generate categorized product attributes representing the product. A database may be populated with representations of the categorized product attributes.

The given individual indicator may be compared against a list of names of known brands and products, and the given individual indicator may be associated with a matching one of the names of known brands and products in response to detecting a match. In response to failing to detect a match between the individual indicator and the known brands and products, the given individual indicator may be divided into sub-word units, and the sub-word units may be applied to a natural-language processing (NLP) unit to determine a candidate match and a confidence score, the candidate match being one of the list of known brands and products. The given individual indicator may then be associated with the candidate match in response to the confidence score being above a given threshold.

An entry representing the product in an external database may be identified, and the categorized product attributes may be mapped to corresponding product information stored at the entry. The categorized product attributes may then be updated based on a detected difference from the entry.

An external database may be searched for information associated with the product based on the product attributes, and the database may be updated based on the information associated with the product. Derived product attributes may be determined based on at least one of the product attributes, the derived product attributes being absent from the candidate product information. The database may then be populated with representations of the derived product attributes. A map may be generated relating the categorized product attributes to corresponding product information stored at an external database, and a format of the map may be updated based on a format associated with the external database.

A product type may be determined from characteristics of the product packaging. The characteristics of the product packaging may include size or shape. The image of product packaging may be preprocessed by adjusting lighting or other aspects of the image. Extracting the individual indicators may include extracting auxiliary information about the product that is a pseudo-attribute of the product. The auxiliary information about the product may be contextual information about product relevant to a consumer of the product, and the pseudo-attribute of the product may be selected from a list including at least one of the following: source of the product or packaging, environmental considerations relating to the product or packaging, associations of the product or packaging with a social cause.

The model created by machine learning may be trained by identifying relevance of the product attributes by a human and inputting that information into a neural network or convolution neural network. Optical character recognition may be applied to the individual indicator, and applying the rule may include applying natural language processing.

The product attributes may be forwarded of data in a prescribed order to a distal database. Optical image processing may be performed on an image of a product from a requesting client and, responsively, the discrete items of data may be returned in a prescribed order to the requesting client in less than 10 minutes from a time of receipt of the image.

After extracting the individual indicators, at least one rule may be applied to an individual indicator having a confidence level of below 96% until the confidence level is improved to a confidence level above 96%. Applying the rule includes applying a rule that identifies the individual indicator for evaluation by a reviewer, and further comprising updating the database based on an input by the reviewer.

Further embodiments include a computer-implemented method of enabling storage of product information in a database. A model created by machine learning may be applied to candidate product information within a digital representation of product packaging to discern indicators of product attributes on the packaging from indicators of non-product attributes. Representations of the product attributes may then be processed to enable storage of the representations in corresponding fields of a database. Indicia of the candidate product information may be identified as a function of size, shape, or combination thereof of the product packaging. A rule may be applied to identify the candidate product information. Processing the representations of the product attributes may include arranging the representations in an order consistent with corresponding fields of a database or with metadata labels that enable the database to store the corresponding representations in corresponding fields.

Further embodiments include a computer-implemented method of auditing stored product information in a database. Product information may be retrieved from a database, and a model created by machine learning may be applied to candidate product information within a digital representation of product packaging to discern indicators of product attributes on the packaging from indicators of non-product attributes. Representations of the product attributes may be processed to enable storage of the representations in corresponding fields of a database. The product information retrieved from the database may then be audited by comparing the product information with corresponding representations of the product information gleaned by applying the model to the candidate product information.

Further embodiments may include a system for determining product information. An image scanner may be configured to identify candidate product information within an image of product packaging of a product. A data processor may be configured to 1) apply a model created by machine learning to the candidate product information to discern indicators of product attributes from indicators of non-product attributes of the candidate product information, 2) extract individual indicators from the indicators of product attributes, 3) in response to a determination that additional confidence is needed for a given individual indicator, apply a rule to identify unique product information from the given individual indicator, and 4) apply a taxonomy to the product attributes based on the individual indicators to generate categorized product attributes representing the product. A database may be configured to store the categorized product attributes.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a system in an example embodiment.

FIG. 2 is a block diagram of a product scanner in one embodiment.

FIG. 3 is a block diagram of a review system in one embodiment.

FIG. 4 is a block diagram of an image scanner in one embodiment.

FIG. 5 is a block diagram of a monitoring system in one embodiment.

FIG. 6 is a flow diagram of a process of populating a database with product information in one embodiment.

FIGS. 7A-C illustrate a table of categorized product attributes in one embodiment.

FIG. 8 illustrates a computer network or similar digital processing environment in which embodiments of the present invention may be implemented.

FIG. 9 is a diagram of an example internal structure of a computer (e.g., client processor/device or server computers) in the computer system of FIG. 8.

### DETAILED DESCRIPTION

A description of example embodiments follows.

Example embodiments, described herein, may be implemented to provide for the capture, analysis and organization of product information, and may employ computer vision, artificial intelligence (AI) and machine learning (ML). Manufacturers and retailers in the consumer-packaged goods (CPG) industry may implement example embodiments to capture and categorize product information provided as indicators of product attributes on product packaging, and may enhance this data with dietary, allergen, nutritional, and other customer-relevant attributes to improve shopper segmentation and experience. As a result, manufacturers and retailers can ensure accuracy across product listings, increase conversion rates, improve customer engagement, and quickly scale product content across consumer outlets.

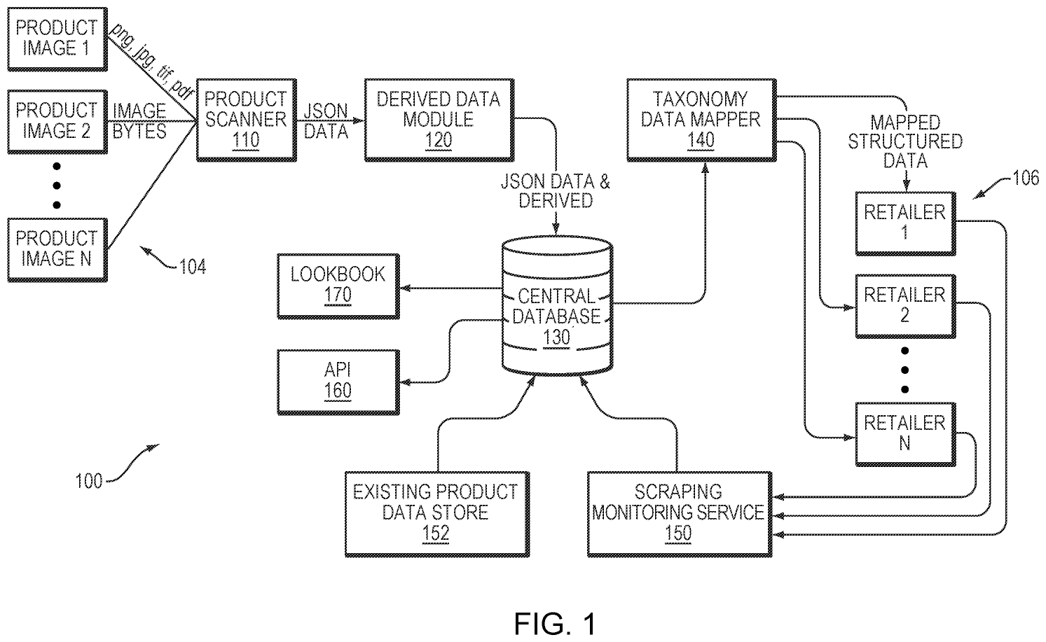

FIG. 1 is a block diagram of a system 100 in an example embodiment, which may capture, analyze, categorize and distribute product information for products, such as consumer packaged goods. The system 100 may be implemented as a distributed computer network comprising one or more computer workstations, servers, and/or mobile computing devices, and may communicate via a communications network (e.g., the Internet) to complete the operations described herein and provide the results to manufacturers, retailer, consumers and/or other users.

The system 100 may include a product scanner 110 configured to read candidate product information (also referred to herein as “indicators of product attributes”) from product images 104. The product images 104 may depict one or more products at a variety of different angles and image qualities, and may be ecommerce (e.g., website-derived) or “live” images gathered from brands, retailers, and/or end consumers (e.g., via a smartphone camera). The system 100 can process the images 104 by extracting, digitizing, and normalizing indicators of product attributes, such as indicators that inform a consumer of a product's ingredients, nutritional chart information, net weight, brand name, product name, certification claims, health claims, flavor characteristics, marketing claims, and/or additional product attributes. This data may be further enriched by using it as an input for additional synthesized product attributes, such as building allergen and diet information from the ingredients data.

The derived data module 120 may be configured to receive representations (i.e., digitized versions of indicators) of the product attributes output by the product scanner 110, and may process the representations of the product attributes to determine derived product attributes for the products. In doing so, the derived data module 120 may implement a combination of natural language processing and computer vision, and can derive product attributes that are not directly indicated via the product images 104. For example, the derived data module 120 may process representations of the product ingredients, perform a lookup of the product ingredients against a database cross-referencing the ingredients and corresponding attributes, and tag a representation of the product with those corresponding attributes, such as allergens, dietary attributes, and nutritional data (e.g. “peanut allergy,” “good source of protein,” “low sodium,” “south beach diet”). The derived data module 120 may also determine metadata information from the product attributes and/or the product images 104, such as a product category (e.g., “dairy,” “meat”) and image orientation.

A central database 130 may be configured to store a range of data as described below, including the product information determined from the product images 104 via the product scanner 120 and the derived data module 120, product data provided by an existing product data store 152, product data scraped and normalized from retail websites (e.g., from retailer databases 106) processed and categorized product data, transactional data, and/or recent snapshots. Even after product data has been properly digitized to a standardized format, external databases (e.g., retailer, manufacturer or consumer service databases) may not share the same data schema as configured in the central database 130, with varying names, data types, fields, and completeness.

To alleviate the task of manually performing these conversions, which may require the same amount of time as the transcription task itself, the system 100 may include a taxonomy data mapper 140 configured to map the product data to known external taxonomies for external databases such as retailer databases 106 as well as custom-built taxonomies that are maintained in external databases by other entities. This automatic mapping can be determined via data access, and can convert data between different data schemas, such as retailer-specific data schemas, brand-specific data schemas, category-specific data schemas, and data formats (e.g. csv, json, xlsx).

The product images 104 may not always provide reliable information from which to derive information about the product depicted in the image. For example, there may be a difference between the information depicted among multiple product images (e.g., two different images may each contain ingredient information that conflict with one another). Additionally, product images may be out-of-date while the underlying brands or retailer's digital information is accurate according to reference information (e.g., from a retailer database 106). As a solution, the system 100 may compare data between the images 104 as well as compare digitized information from all images to existing information provided by the brands (e.g., at the retailer databases 106 and/or an existing product data store 152) to create post-processing reports that identify inconsistent data for further review. This process may ensure that an entity (e.g., the brand owner) can either update existing systems with the digitized image data or provide updated product images that accurately reflect the updated data.

Further, despite accurate data transcription, error resolution, and data mapping, an ecommerce site or database may still become out of sync with the information extracted from the product images 104. To address such differences, a monitoring system 150 may periodically poll the retailer databases 106 (e.g., via an ecommerce website operated by the retailer) for the presented data, and may issue an alert if the retailer database 106 data has become inconsistent with the product information maintained at the central database 130. Additionally, product information and related data can be reviewed and updated via a lookbook 170 and/or an application programming interface (API) 160. The lookbook 160 and API 160 may be implemented via networked devices (e.g., workstation, mobile device) in communication with the central database 130. The API 160 may enable a user to directly read and update product attributes and/or related data stored at the central database 130. The lookbook 160 may provide a user interface (e.g., a web page) that formats and displays the product attributes and/or related data from the central database 130, enabling a user to look up and view the products with their corresponding images and product attributes. The lookbook 170 may also enable the user to query and filter products based on product attributes (e.g., display only gluten-free products), and may receive user input to update or correct the displayed information, thereby updating the product attributes and/or related data stored at the central database 130.

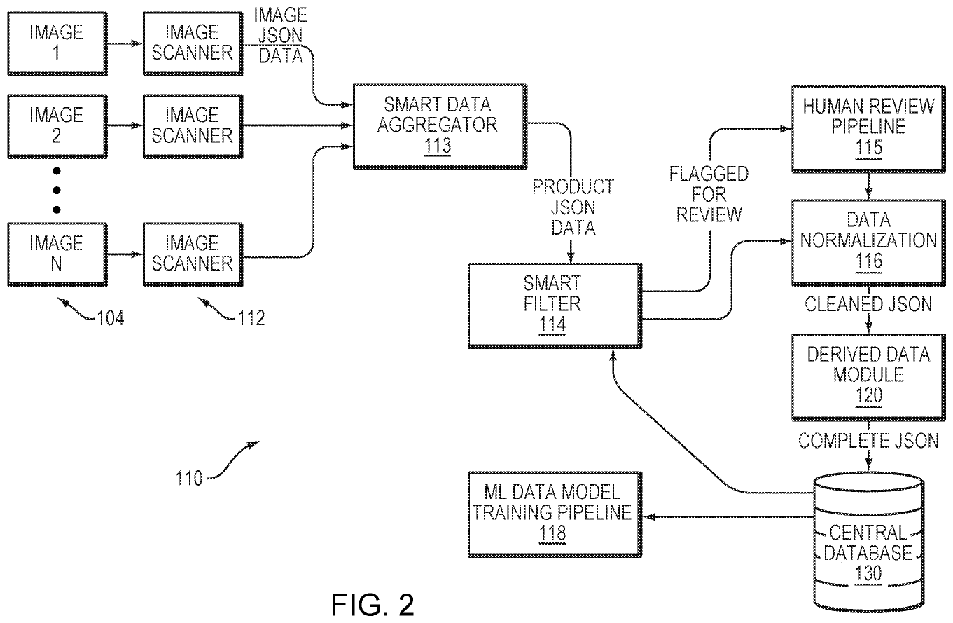

FIG. 2 illustrates the product scanner 110 in further detail. The product scanner 110 may accept multiple product images 104 for a single product as input. Each image 104 may be individually passed through one or more image scanners 112 to extract core product information such as an ingredients string, product name, brand name, net weight values, nutrition values and units, certifications, claims, and flavor profiles. Representations of the information scanned from the images 104 is then passed to a data aggregator 113 to reconcile separate pieces of information across the images 104. Specifically, the data aggregator 113 may receive representations of multiple extracted product data documents corresponding to the product images 104, address discrepancies among the data present in the data documents, combine the data into a single data set, and cross-check the data to detect and correct any errors or missing data. The data inputs to the data aggregator 113 may be, for example, multiple j son-format documents containing individual extracted fields. The data aggregator 113 may also implement computer vision on the images 104 to determine which of the images 104 are most likely to yield the best results where multiple image sources are available (e.g. multiple ingredients images). The data aggregator 113 may also filter and select results based on coherency with known values (e.g., percent of ingredient words that match known ingredient words).

After the data for the product is combined at the product level, the data aggregator 113 then passes the data through the smart filter 114, which may determine whether any of the data should be flagged for human review. To do so, the smart filter 114 may implement posterior model confidence scores, and may use derived metadata information from the product information or product images 104 such as nutrition chart type, container type, product category, image resolution, image blurriness, and image skewness. The smart filter 114 may then cross check values against configured rules. For example, the smart filter 114 may verify whether the values for total calorie count, fat calories, carbohydrate calories, and protein calories are correct by applying a relevant rule (e.g., Total Calories=9*Total Fat+4*Protein+4*Carbohydrates) to calculate a reference value that is compared against the values retrieved from the product images 104. The smart filter 104 may also directly compare nutritional values against ingredients in accordance with configured rules relating known ingredients and nutritional values. Inconsistent data among the product images 104, where both sources are determined to pass a quality threshold, is flagged for human review. The smart filter 114 may also use a meta-model that trained on human reviewed corrections. The smart filter 114 may use a combination of rules, natural language processing, and computer vision to determine if the data is incoherent, has low model confidence, or is of a type that is likely to yield poor accuracy (e.g., transparent cylindrical containers like those used for fruit cups may be flagged for review).

If the data is determined to be potentially inaccurate (e.g., by failing to meet a confidence threshold), the smart filter 114 may forward it to the human review pipeline 115, where the data is reviewed and corrected by human annotators as described in further detail below. Data that has passed the smart filter 114 or has been corrected by the human review pipeline 115 may then be processed by the data normalization module 116, which may apply formatting revisions to create a data set that is uniform across the scanned products. In particular, the data normalization module 116 may format all fields of the product information uniformly, capitalize a selection of values (e.g., ingredients) in accordance with configured rules, and configure the data format to allow for the application of updates to taxonomy or formatting. The derived data module 120, described above, may then enhance the normalized data and provide an enhanced data set (e.g., a json file), including the product attributes from the smart filter 114 and derived product attributes from the derived data module 120, to the central database 130 for storage and organization with entries corresponding to other products.

Labeled data that has been human-reviewed and corrected may also be used in a process of training improved models and improving operation of the smart filter functionality via a machine learning data model training pipeline 118. Here, data that is labeled via the human review pipeline 115 may be used to train new machine learning models including the models implemented by the smart filter 114. The pipeline 118 may train the smart filter 114 meta-model based on data summaries to improve the determination of whether data should be reviewed by the human review pipeline 115. The pipeline 118 may also generate training data for optical character recognition (OCR) models employed by the image scanners 112.

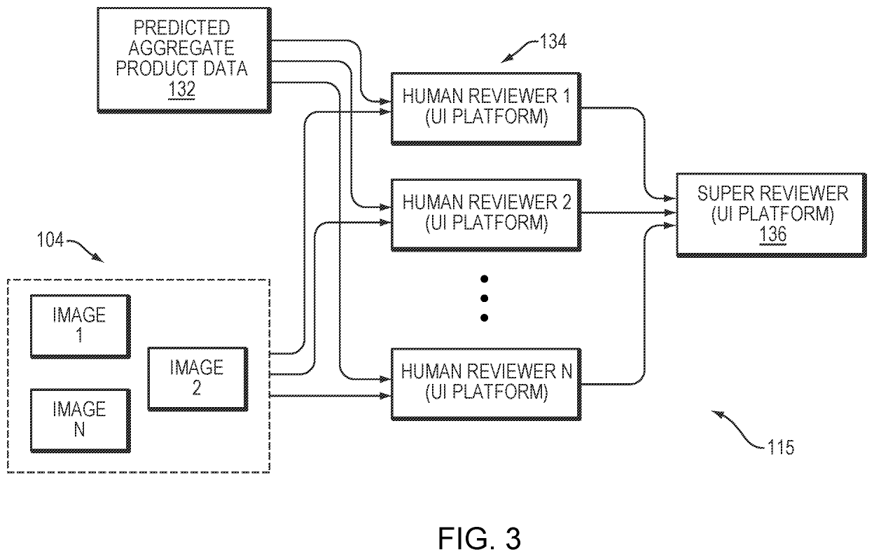

FIG. 3 illustrates the human review pipeline 115 in further detail. The pipeline 115 may include a first tier of human review platforms 134, each of which may include a networked computing device (e.g., workstation, tablet) configured with a user interface (UI) that retrieves and displays the product images 104 and predicted aggregate product data 132 that was flagged for review by the smart filter 114. The UI of the human review platforms 134 may be configured to assist a human user in reviewing the flagged data by highlighting the portions of the predicted aggregate product data 132 that were identified by the smart filter 114 as having a confidence score below a given threshold (e.g., a predicted brand or product name), or product attributes that cannot be resolved by the smart filter 114 (e.g., multiple versions of nutrition data that conflict with one another, based on different product images 104). The human review platforms 134 may also display the flagged data for review as one or more pairings, each pairing including a portion of the predicted aggregate product data 132 and a segment of the product images 104 from which the portion of the predicted aggregate product data was derived. The human review platforms 134 may accept user input by a human review, who may select or enter a correction to the predicted aggregate product data 132 based on their review of the product images 104. In response, the human review platforms 134 may then correct the predicted aggregate product data 132 based on this input, and forward the corrected product attributes to the data normalization module 116 as described above. Optionally, a super reviewer platform 136 may be configured comparably to the human review platforms 134, but is configured to receive and display flagged data that encounters conflicting corrections by two or more of the human review platforms 134. A human reviewer operating the super reviewer platform 136 may provide input to resolve such conflicts before forwarding the corrected product attributes to the data normalization module 116. Thus, the super reviewer platform 136 may operate as a final arbiter of corrections to the predicted aggregate product data 132.

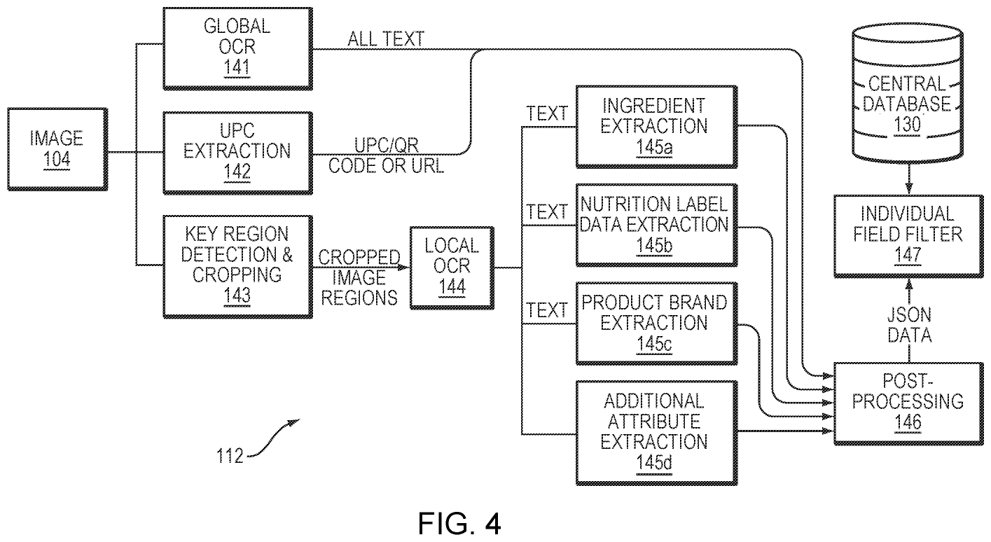

FIG. 4 illustrates the image scanner 112 component of the product scanner 110 in further detail. The image scanner 112 may process an individual product image 104 and extract available product information that is present in the image 104. This process may be done via a combination of a global OCR module 141, which extracts all text from the image into a single text file to be analyzed, as well as a region detector and cropping module 143 and a local OCR module 144, which first identifies key pixel regions in the image (e.g., Brand Name, Product Name, Ingredients, Nutrition Chart, Claims, etc.) before cropping those regions to enable localized text strings to be extracted. Data (e.g., candidate product information) may then be extracted and post-processed via custom rules and natural language processing models via field extractors 145 and a post processing module 146, respectively, where values may be cross-checked against the central database 130. The local OCR path can be recursive, wherein if values are deemed to be incoherent by an individual field filter 147, the next most likely cropped section can be used to pass through the extraction step.

The global OCR module 141 may perform a full text dump of all words found in the product image 104, read from left to right along the image. The resulting text file can be used for a full text search for unique keywords such as claims and brand/product names. The universal product code (UPC) extraction module 142 may extract a barcode and/or QR code of the product from the product image 104. The region detector and cropping module 143 may identify key regions using semantic segmentation via a convolutional neural network (CNN). Those regions may be defined by bounding boxes and pixel masks, and key regions may include brand name, product name, net weight, product count, ingredients, nutrition label, certifications, claims, cooking instructions, product description. Accordingly, the region detector and cropping module 143 may crop portions of the image 104 by bounding boxes and masked by pixel values before sending the cropped image regions to the local OCR module 144. A given product image 144 may have several cropped regions (e.g., up to 50 or more) corresponding to various identified regions of interest for processing by the local OCR module 144. The local OCR module, in turn, may transcribe the text of each of the cropped regions, generating a full text string output of all text data found in the cropped images. This raw text data may be smaller in size than that generated by the global OCR 141, and may require a cleaning and refinement via field extractors 145.

The field extractors 145a-d may include a number of different processor modules configured to identify and extract specific types of product attributes from the text output by the local OCR module 144. If any of the text candidates fail to pass their individual filters of the field extractors 145a-d, the results may be flagged by the individual field filter 147 and the results may be discarded. If there are additional object detections for that field/class from the image detector, then a new cropped portion of the image may be passed through the field extractor in a recursive manner.

An ingredient field extractor 145a may operate by first filtering candidate ingredients to determine if the detection was correct, and may do so by building a logistic regression classifier that takes as input: the number of commas in the string, the length of the string, presence of certain keywords in the string e.g. “ingredients” and “contains” and percentage of ingredients that match a list of known ingredients. Ingredient data may be corrected using various methods of spelling correction including calculating the Levenshtein distance between unmatched ingredients and all known ingredients to determine if a match exceeds a given required “string similarity” where string similarity is defined as: String similarity=LevenshteinDistance(str1,str2)/max(len(str1), len(str2)).

To extract nutrition information, the key region detection module 143, local OCR module 144, and nutrition field extractor 145b may operate first to determine a nutrition chart type using a CNN that classifies the whole cropped section image to one of the following classes:
a) Vertical single-column chart
b) Horizontal single-column chart
c) Vertical multi-column chart
d) Horizontal multi-column chart
e) Horizontal paragraph chart

In an example operation, if the detected class is type (a), (c), or (e), the extractor 145b may pass the image through a regular OCR extractor. If the detected class is type (b) or (d), the modules 143, 144 may horizontally parse the chart before passing the data subsequently to OCR extractors. The nutrition field extractor 145b may then associate values and percent daily value with nutrient names. For example, the text string “Protein 9 g 15%” may be extracted to the following product attributes:
a) Nutrient name=Protein
b) Nutrient value=9
c) Nutrient percent daily value=15

For multi-column charts including (c) and (d), column headers may be parsed as well as multiple values.

The product/brand extractor 145c may identify brand/product name candidates from the text strings provided by the local OCR module 144 and check the candidate(s) against a list of known (reference) brands and/or product names. If a candidate brand name matches a known brand, then a candidate product name may be compared against a list of known product names associated with the matching brand. If either the candidate brand or product names do not match known values, then the product/brand extractor 145c may process the candidates via a brand name vs. product description NLP model. The dataset for this model was developed by extracting text using the global OCR module 141 and then searching for known product and brand names through the text. Product names from the master list were labeled with “product name,” brand names from the list were labeled as “brand name,” and all other surrounding background text was newline separated and labeled as “other description.” In this way, a training dataset was built to accurately distinguish background text from brand and product names. The brand name versus product description NLP model may operate to distinguish between background marketing claims such as “High in protein” or “Heart Healthy” versus out-of-vocabulary brand and product names such as “Oaty O's” or “Apple Zingers” (obscure product names) or “Apple's Harvest” (a fictitious brand name). The model may distinguish between the semantics of general background text and brand name/product name by first encoding the strings to byte pair encodings to tokenize to sub word units. After the words are tokenized, the tokens are converted to a trained embedding space where a hierarchical neural network is applied to extract a “string embedding” that is used to build a classifier between the two classes. If the classifier returns a class of “brand name” or “product name” and the confidence score is above a sufficient threshold, then the extractor 145c may determine the detection to be correct. If this is not the case, then the next most likely object detection result for brand name or product name may be used with a new cropped portion of the image in a recursive manner.

An additional attribute extractor 145d may include one or more distinct modules, and can provide for extracting several additional product attributes from the text provided by the local OCR module 144. For example, the extractor 145d may extract product flavor attributes for the product using the same class as product name in the object detector. If there are multiple detections for product flavor, the extractor 145d may determine whether either detection is a product name or a product flavor by comparing the string against a list of known product flavors (e.g. “chocolate”). If there is a match, then the extractor 145d may designate the product name as the product flavor. If there is no match, then the extractor 145d may concatenate multiple product name detections as a single product name.

The additional attribute extractor 145d may also determine a net weight of the product from the text provided by the local OCR module 144. The extractor 145d may require an extracted net weight string to have certain identifiers to be present (e.g. “nt” & “wt” or “net” and “weight”) and to contain a numeric value. The extractor 145d may parse such a raw string to separate values such as “number of units per package,” “total net weight,” “individual unit net weight,” and “individual net weight grams.” For example, the string “22-0.9 OZ (25.5 g) POUCHES NET WT 19.8 OZ (561 g)” may be parsed as follows:
a) Number of units per package=22
b) Total net weight=19.8 OZ
c) Individual unit net weight=0.9 OZ
d) Individual net weight grams=25.5

The post-processing module 146 may perform normalization and error correction on representations of the categorized product attributes provided by the extractor modules 145a-d. These operations may include spelling correction and common transcription error correction. For example, the post-processing module 146 may receive a representation of the product attribute “protein 10 9” and correct it to “protein 10 g” by extracting and separating protein unit=“g”, protein value=10, protein daily value=10% from raw protein value.

The individual field filter 147 may determine whether individual field values are appropriate for a given attribute category. For example, the filter 147 may determine whether a minimum threshold for percentage of identified ingredients is met, and may use model confidence scores to make such a determination. If a field fails the filter 147, other candidate regions from the region detector 143 may be applied to determine a replacement for that field, and the local OCR module 144 may be run on that new region for that category. This process may be performed recursively until either there are no more potential detected regions or one of the fields passes the filter 147. For example, the region detector 143 may identify an area around the text “CHOCOLATE SANDWICH COOKIES” as “Net Weight” because the text is written in a similar font, location, and sizing as a product's net weight description. After identifying the region, the text “CHOCOLATE SANDWICH COOKIES” would be extracted via the OCR and then passed to the field extractors and individual field filter 147. It would fail this filter because the string does not contain relevant indicators namely the keywords, “NET”, “WEIGHT”, “NT.”, or “WT.” After failing the filter, the region detector would then be resampled. If another candidate region was available, that text would go through the OCR and field extractor process until the correct Net Weight data has been extracted e.g. “NET WT 1 LB 1 OZ (482 g)”

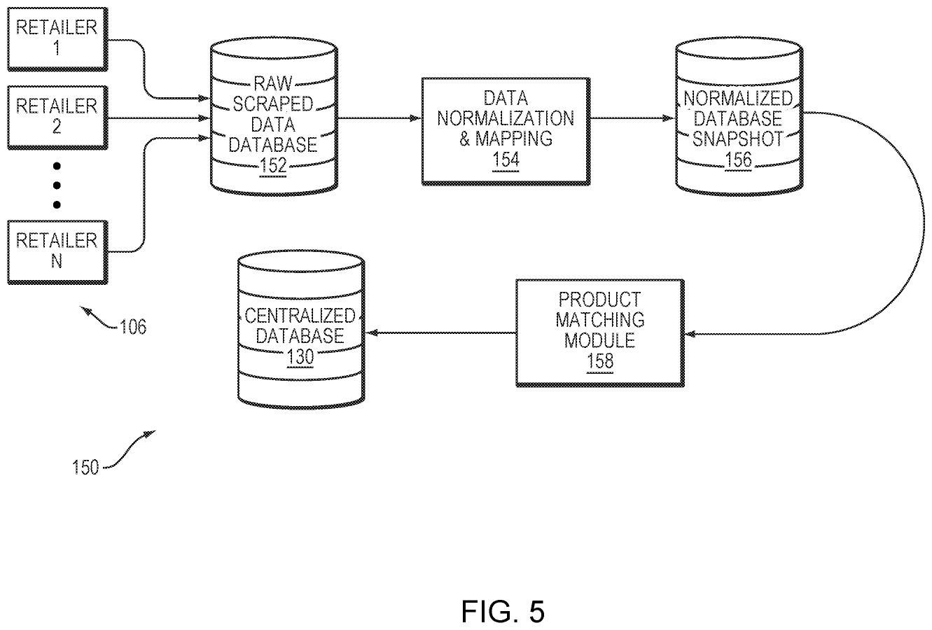

FIG. 5 illustrates the monitoring system 150 in further detail. The monitoring system 150 may compare scraped product data against data that has been provided to retailers to determine that accurate data is flowing through all channels. Discrepancies may be reported to users so that corrective action can be taken.

The monitoring system 150 may operate to periodically poll the retailer databases 106 (e.g., via an ecommerce website operated by the retailer) for the product information available on those databases and store that information to a raw scraped data database 152. The scraped data may include product images and core product data presented in text format. Products across multiple sources may need to be matched to provide data for cross-checking as well as use by the monitoring system 150. If a UPC/QR code or an external product identifier exists, the system 150 may first identify a product match based on those codes (many retailers' websites present a SKU but not a UPC, and often there are no images with the UPC). The data normalization and mapping module 154 may perform an initial cleaning and normalization on the raw scraped product data, and most recent data sources may be added to place into a normalized database 156. A product matching module 158 may then search the central database 130 for potential matches to the normalized scraped data, and may implement a term frequency-inverse document frequency (TF-IDF) analysis to determine a best match. Pre-clustering may begin by calculating TF-IDF score between pairwise titles and descriptions, and products that have a TF-IDF score above a certain threshold are considered for future matches. Image embeddings may be extracted using a pre-trained CNN model (e.g., ResNet). TF-IDF vectors, image embeddings, and other summary information are passed to a Random Forest classification model that predicts whether or not two products are the same. If the confidence score from the random forest model is above a threshold, the product matching module 158 may identify them as relating to the same product and, accordingly, determine a matched product. Matched products may be assigned a common product ID that identifies products across multiple sources.

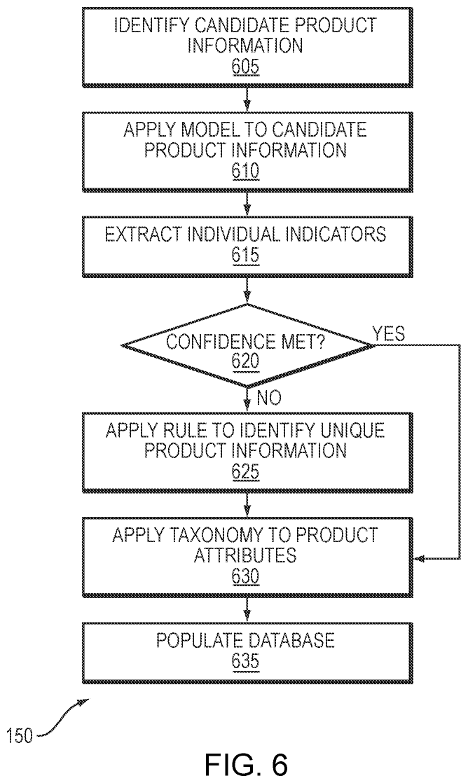

FIG. 6 is a flow diagram of a process 600 of populating a database with product information in one embodiment. The process 600 may be carried out by the system 100 to populate a database, such as the central database 130, with product attributes of a product. With reference to FIGS. 1-5, the image scanners 112 may identify candidate product information within one or more images of product packaging of a product (e.g., product images 104) (605). In particular, the initial candidate product information may be identified by the Key Region Detection & Cropping module 143. The image scanner 112 may then apply a model created by machine learning to the candidate product information to discern indicators of product attributes from indicators of non-product attributes of the candidate product information (610). Specifically, raw information may be extracted using the local OCR module 144. The image scanner 112 may extract individual indicators from the indicators of product attributes (615). Individual indicators may be processed and extracted using the field extractors 145a-d and then the post-processing module 146. Then, individual indicators may be gathered across images in the smart data aggregator 113 to be combined at the product level.

In response to a determination that additional confidence is needed for a given individual indicator (620), the product scanner 110 may apply a rule to identify unique product information from the given individual indicator (625). Specifically, confidence may be determined on two levels. The first level may be at the image scanner 112, where the individual field filter module 147 may determine if an individual detected region is low confidence and resample. The second level may be at the product scanner 110, where the smart filter 114 may determine if confidence is low and send to the human review pipeline 115 if true. Data may then be normalized and formatted to a unified taxonomy using the data normalization module 116. The product scanner 110 may then apply a taxonomy to the product attributes based on the individual indicators to generate categorized product attributes representing the product (630). Specifically, data can be mapped to various external data formats and data stores using the Taxonomy Data Mapper 140. The central database 130 may then accept and populate its database with the categorized product attributes (635). Both internal databases such as the central database 130 as well as external databases such as retailers 106 and a user's existing product data store 152 can then be populated using the API 160.

Further, the product/brand extractor 145c may compare the given individual indicator against a list of names of known brands and products, and the product/brand extractor 145c may associate the given individual indicator with a matching one of the names of known brands and products in response to detecting a match. In response to failing to detect a match between the individual indicator and the known brands and products, the product/brand extractor 145c may divide the given individual indicator into sub-word units, and apply the sub-word units to a natural-language processing (NLP) unit to determine a candidate match and a confidence score, the candidate match being one of the list of known brands and products. The 145c may then associate the given individual indicator with the candidate match in response to the confidence score being above a given threshold.

The product matching module 158 may identifying an entry representing the product in an external database, and the data normalization & mapping module 154 may map the categorized product attributes to corresponding product information stored at the entry. The scraping monitoring service 150 may alert a detected difference and the API 160 may then update the categorized product attributes based on a detected difference from the entry.

The lookbook 170 may search an external database for information associated with the product based on the product attributes, and the API 160 may update the database 103 based on the information associated with the product.

The derived data module 120 may determine derived product attributes based on at least one of the product attributes, the derived product attributes being absent from the candidate product information; and may populate the database with representations of the derived product attributes.

The taxonomy data mapper 140 may generate a map relating the categorized product attributes to corresponding product information stored at an external database, and the taxonomy data mapper 140 may update a format of the map based on a format associated with the external database.

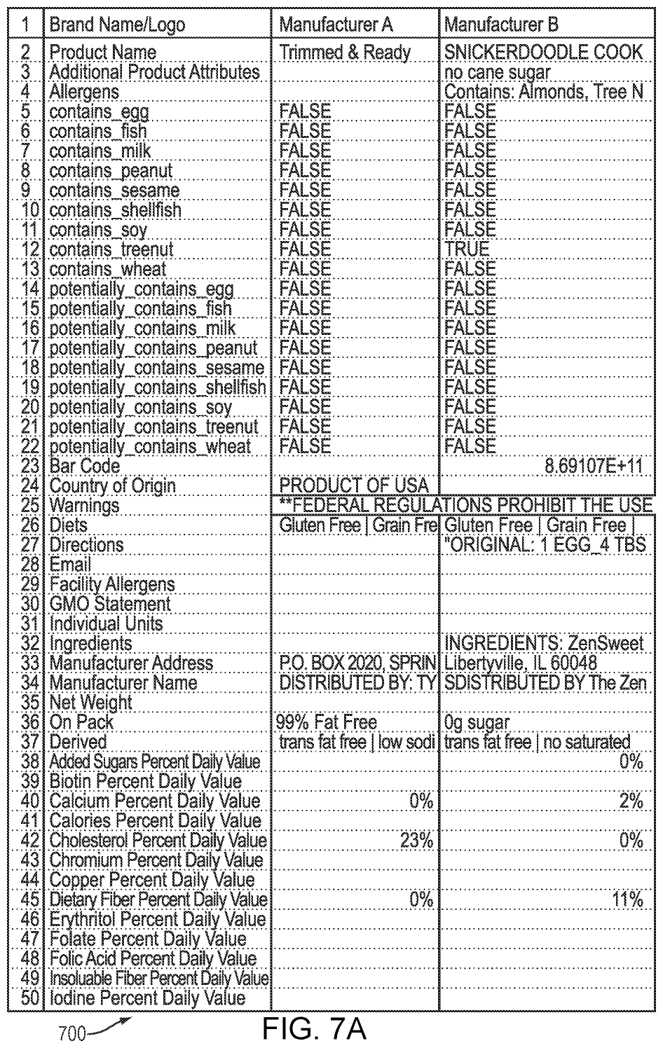

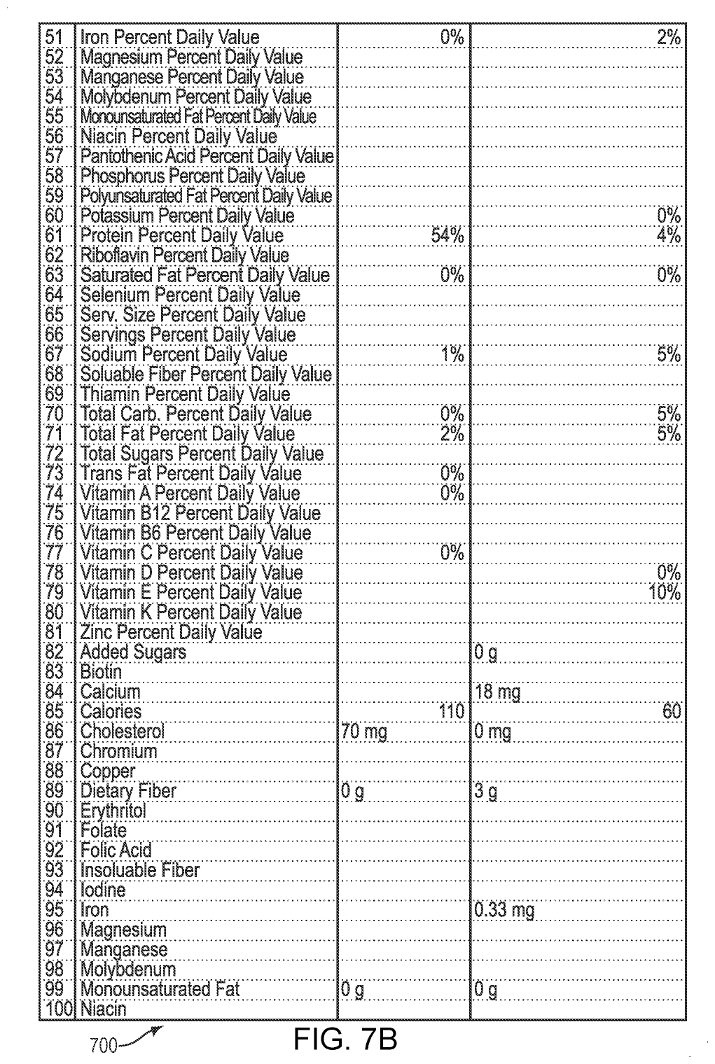

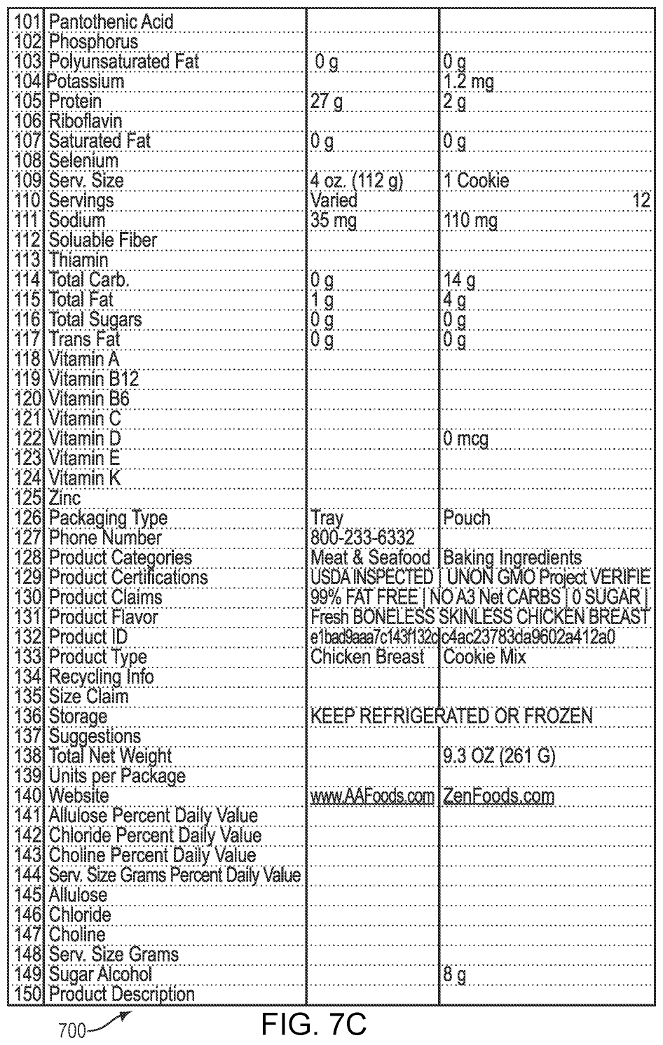

FIGS. 7A-C illustrate a table of categorized product attributes 700 in one embodiment. The product attributes 700 may be identified and generated by the product scanner 110 and derived data module 120 as described above, and may be stored at the central database 130 in a table, database or data interchange format (e.g., json). The first (leftmost) column identifies each row number for clarity, the second column indicates the category of each product attribute, and the third and fourth columns each comprise the product attributes for a first product and a second product, respectively. The rows comprise several different categories of product attributes, including but not limited to:
a) Product brand name (row 1)
b) Product name (row 2)
c) Additional product attributes read from package (row 3)
d) Allergens as indicated on package (row 4)
e) Derived allergen fields (rows 5-22)
f) Nutrient Percent Daily Values (rows 38-81)
g) Nutrient values (rows 82-125)
h) Additional product attributes identified from package text or derived (rows 126-140)

Additional product attributes may include indicators of compatibility with one or more given diets (e.g., vegan, ketogenic, paleo diet), which can be either identified directly from the product package or derived by the derived data module 120 based on the identified ingredients. Additional derived product attributes may include attributes about the product images, such as image orientation.

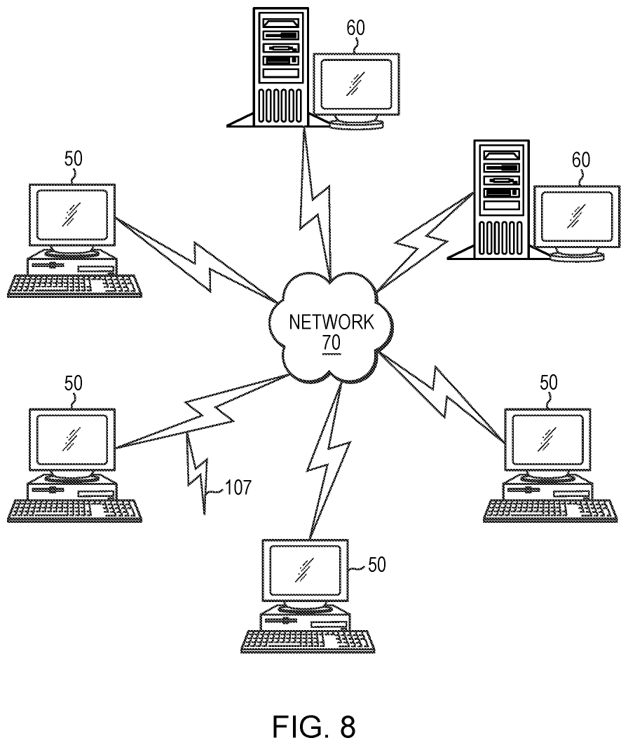

FIG. 8 illustrates a computer network or similar digital processing environment in which embodiments of the present invention may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

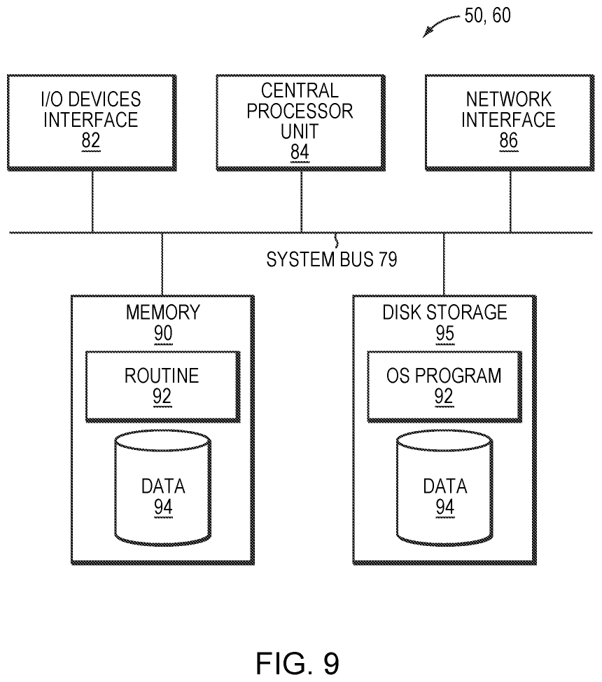

FIG. 9 is a diagram of an example internal structure of a computer (e.g., client processor/device 50 or server computers 60) in the computer system of FIG. 8. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 8). Memory 90 provides volatile storage for computer software instructions 92 and data 94 used to implement an embodiment of the present invention (e.g., one or more components of the system 100, including the product scanner 110, derived data module 120, central database 130, taxonomy data mapper 140, and the scraping monitoring system 150). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection.

Exemplifications

In an example implementation of the system 100 described above, the system 100 may perform post-processing of product information as follows:

Ingredients:
a) Clean ingredients by stripping away punctuation, removing stop words, and reduce to individual words.
b) Filter sections of text that are not ingredients e.g. “Manufactured by, distributed by”
c) If less than the minimum required ingredients and less than the minimum percent of ingredients or text is short and no ingredient matches or if the ingredients are not 2 in a row then remove detection and go to next if present.
d) Perform spelling correction and count the minimum number of words that matched perfectly to known ingredients words.
e) If ingredients words are less than minimum percent exact match or there were words with no match or if parentheses don't match or object detection confidence was low, then run ingredients text through BERT for normalization.

Nutrition Label:
a) Split extracted text by line.
b) Pre-clean by replacing common mistakes of variations of “O” vs 0 with units “mg”
c) 24omcg=>240 mcg
d) If multiple columns is detected then pass to multi-column parser
e) Extract each nutrition item by line with the corresponding percent daily value
f) Specific module to parse serving size units, ounces, and grams
g) Clean serving size by fixing common mistakes such as commonly “9)”=>“g)” or “0z”=>“oz” or “1b”=>“lb”
h) Determine if ounces and grams reported values are the same and flag if they are not.
i) Extract floating point numbers from text and associate with appropriate nutrition item.
j) Calculate percent daily values from known table of recommended nutrition values and flag if the values are not equal.
k) Compare to known distribution of nutrition value ranges and flag if any value exceeds and highlight for labeler.
l) Cross-check calories, carbs, protein, and total fat with equation and flag if not equal.
m) Protein*4+Total Fat*9+Carbs*4=Calories
n) Determine nutrition chart type and flag if missing mandatory nutrition fields

Brand Name:
a) Calculate string similarity between list of known brands and spelling correct above threshold.
b) If confidence score on detection is low and extracted text isn't in list of known brands then pass to NLP filter.
c) If NLP filter confidence is too low, remove detection and go on to next brand name detection if there is one.
d) New brand name is flagged for future review by QA team and potential integration into list.
e) Allow up to 2 brand name areas to pass through filter.
f) Concatenate all brand name strings and compare to database for normalization and flag if not present.

Product Name/Flavor:
a) Allow up to 3 product name detections to pass through filter.
b) If brand name matched, get known product names for brand and perform string similarity comparison for product string. Correct if above match threshold.
c) If confidence score on detection is low and extracted text isn't in list of known products then pass to NLP filter.
d) If NLP filter confidence is to low, remove detection and go on to next product name detection if there is one.
e) New brand name is flagged for future review by QA team and potential integration into list.
f) Determine if product name is actually product flavor by using fasttext classifier and list of known flavor values e.g. hazelnut, strawberry, berry blast.
g) Concatenate all product name strings and compare to database for normalization and flag if not present.

Net Weight
a) Determine if net weight contains required text string e.g. “net”, “weight”, “wt”, “fl”, “oz”
   i. If key indicator is not found then delete detection and move on to next most likely if present
b) Net weight is cleaned by normalizing text and replacing common mistakes
   i. For example “½” is replaced with 0.5
   ii. 9)=>g)
   iii. “0z”=>“oz etc.
   iv. Filter for only numbers and relevant net weight keywords
c) Extract ounces, grams, units, number of items per package from string
   i. Parse individual net weight and total net weight
   ii. Extract number of units per package
   iii. Determine the type of units mentioned e.g. ounces, packets, pouches, etc.
d) Normalize ounces and grams based on common mistakes
   i. For example if the number has 4 digits then insert a decimal point in the middle (“1225”=>12.25)
   ii. If net weight ounces is larger than 2 digits and net weight grams is less than 3 then use the value of net weight grams as the ground truth
   iii. If net weight ounces in 1 and net weight grams is not 1 then use the net weight grams value
e) If net weight ounces and net weight grams don't agree then flag for QA review
f) Calculate expected total net weight by multiplying individual net weight by
g) Cross-check individual net weight and total net weight

OCR Text Cleanup Examples: Common ingredients issues with solutions

1) Example OCR extraction: INGREDIENTS: WHOLE GRAIN POPCORN, EXPELLER PRESSED PALM DIL, CANE SUGAR, SEA SALT, MONK FRUIT EXTRACT. The OCR incorrectly identified an “O” as a “D”. In this case, basic spelling correction is applied.

2) Example OCR extraction: INGREDIENTS: SUGAR, PALM OIL, HAZELNUTS, SKIM MILK, COCOA, SOY LECITHIN AS EMULSIFIER, VANILLIN: AN ARTIFICIAL FLAVOR. PRETZEL STICKS: ENRICHED FLOUR (WHEAT FLOUR, NIACIN, IRON, THIAMINE MONONITRATE, RIBOFLAVIN, FOLIC ACID), MALT EXTRACT, CAN SODIUM BICARBONATE AS LEAVENING AGENT, SALT, BAKER'S YEAST, SODIUM HYDROXIDE AS PH CONTROL AGENT. CONTAINS TREE NUTS (HAZELNUTS), MILK, SOY, WHEAT. EXCL. DIST. FERRERO U.S.A, INC., PARSIPPANY, N.J. 07054 MADE IN CANADA. PRETZELS: MADE IN USA FERRERO. Here, the ingredients are adjacent to the distribution information and this string is erroneously added to the ingredients. In response, the system can search for keywords to identify where this section begins and omit it from the final reported ingredients.

3) Example OCR extraction: INGREDIENTS: ENRICHED WHEAT FLOUR (FLOUR, MALTED BARLEY FLOUR, REDUCED IRON, NIACIN, THIAMIN MONONITRATE (VITAMIN B1), RIBOFLAVIN (VITAMIN B2), FOLIC ACID), WATER, SUGAR, YEAST, WHEAT GLUTEN, CORNMEAL, SALT, DEXTROSE, CALCIUM PROPIONATE AND SORBIC ACID (TO PRESERVE FRESHNESS), NATURAL & ARTIFICIAL FLAVORS, MONOGLY CERIDES, SOYBEAN OIL, CELLULOSE GUM, CITRIC ACID, RED 40 LAKE, XANTHAN GUM, BLUE 2 LAKE, DRIED BLUEBERRIES BLUE 1 LAKE, SUCRALOSE, SOY LECITHIN. R18-114-300624 CONTAINS WHEAT, SOY. MADE IN A BAKERY THAT MAY ALSO USE MILK, EGG, WALNUTS. Here, a product ID was captured as part of the image segmentation process. Because this word does not match any known ingredients values, it may simply be removed. Further, an ingredient spanned a line break and a hyphen was used. However, there was a space added afterward. This issue can be fixed by simply removing all hyphens; however, it may be uncertain whether this character combination might occur elsewhere legitimately. Additionally, because this word is split in half, word-based spelling correction will fail. If the system is unable to match words to known ingredients by simple spelling correction, then it may run the string through BERT to have all grammar/spelling mistakes fixed.

Brand/Product Name: Common issues with brand/product name usually involve ocr read errors and incorrect transcription. The easiest solution to correct these is if the error is close enough to a known brand/product names, a “fuzzy” match can be made. However, a larger issue may be false positive detections. Even if there is 99% coverage for brand/product names, there are still brands that don't exist in our list and additionally new brands/products are being created all the time. Thus, it cannot be presumed that, just because a detection doesn't match known values, that it is incorrect. Therefore, the system may be configured to identify which of the below strings are correct detections and which are incorrect:
a) “Not from artificial sources”: Product Description
b) “Fizzly”: Likely a brand but could be a nonce word description
c) “100% Organic”: Product Description
d) “CapriSun”: Odd brand name (present in our brand list)
e) “Heart Healthy!”: Product Description
f) “Healthy Oats”: Could be a product name, brand name, or product description
g) “Berry blast”: Likely a product flavor but could be a marketing description
h) “Real fruit”: Likely product description
i) “Fruit rings”: Could be a product name, brand name, or product description
j) “100% Pure cane sugar”: Could be the product itself or a description of the ingredients
k) “Frontier Woman”: This is a brand name but could be a marketing description
l) “Flavor-FULL”: Marketing description in odd format

One approach to the problem above is to build a bag of words model that will identify keywords for product descriptions and then filter out these keywords. The problem with this approach is that the space for product descriptions is varied and unlimited. Consider the above marketing description “Flavor-FULL” or the brand name “frontier woman”. It is unlikely that a general bag of words model that was not trained on these specific examples could differentiate between one being a marketing description and the other a brand name. Additionally, people may make up marketing words such as “fizzly” to describe a soda which may be just as likely to be a brand name or even a product name. One problem with a bag of words approach is that it cannot handle out-of-vocabulary words, which are common when dealing with brands, product names, and product descriptions.

To solve this problem, the system may simply determine if the string matches to a known list of brands and products. If it does, then we mark it correct and no further processing is necessary. If it does not, then it may be passed to the NLP model that analyzes the semantics of the text and determine if it “sounds like” a brand or product name or product description. This may be done by first tokenizing the string into sub-word units using the byte-pair encoding algorithm. This might convert the string “fizzly” to [“fiz”, “z”, “ly”]. The system may then convert all of the tokens to an embedding space and use a deep learning model (FastText) to categorize the semantically summarized string. This model was trained on a large scrape of images for known product names, brand names, and product descriptions. Additionally, the model was trained specifically on the output of our OCR model, so the model is robust to ocr transcription errors. Thus, even if in the above example, “fizzly” was incorrectly transcribed as “fizz1y” (with the l being mistranscribed as a “one”), the model may still understand the semantics. The model may achieve separation of product descriptions with high accuracy (e.g., 93% accuracy). A fairly high confidence threshold may be set on this filter so that only allow brands/product are allowed to pass through that are very likely to be correct. This favors precision over recall as we prefer to not propose anything if the model does not meet a confidence threshold. Thus, in the above example, even though the incorrect “fizz1y” may have been identified as a brand, the model likely had a low confidence in the proposal, and so the detection would be removed.

Another common problem is with the image segmentation itself. Sometimes, the image segmentation itself grabs some small portion of surrounding text which creates issues for the OCR system. This problem can be addressed by ignoring text that is very disparate in size but cannot be eliminated entirely.

Net Weight: Most net weights follow a fairly simple schema (e.g., “NET WT 9 OZ (255 g)”). From this example, the following information can be extracted and derived:
a) Individual Net weight ounces: 9.0
b) Individual Net weight grams: 255
c) Number of units per package: 1
d) Total Net weight ounces: 9.0
e) Total net weight grams: 255

However, a vast amount of variation may be found in this piece of information, such as:
a) 10-⅞ OZ (25 g) BAGS NET WT 8.75 OZ (248 g)
b) 10×⅞ OZ (25 g) BAGS NET WT 8.75 OZ (248 g)
c) 10/0.9 OZ (25 g) BAGS NET WT 8.75 OZ (248 g)
d) NET WT 20 OZ (1.25 LBS) (560 g) 20-1 OZ (28 g) PACKS

In addition to the usual OCR read errors such as confusing “9” and “g”, the massive variations in the way that this string may be reported should be addressed. General text extraction can be performed by extracting relevant keywords associated with units e.g. (packs, slices, pouches, bags etc.) as well as extracting all of the relevant floating point numbers. By parsing both the net weight in ounces and net weight in grams, the system can achieve a high-level of accuracy by cross-checking the two values and flagging for human review if they are not equal. The system can also cross-check individual vs. total net weight calculations when multiple values are given.

Nutrition: Common OCR read errors are decimals not being read and omitted entirely. Additionally, there are common mistakes around confusion of “0” and “O” and “D” and even “8” or “9” vs. “g”. There are also numeric transcription errors such as confusing “7” and “1” which can create incorrect results. Confusion between alphabetic characters and numeric characters are generally solved with hard-wired rules that we have learned through trial and error. Numeric transcription errors are more challenging, and various cross-checking methods can be implemented, such as comparing to the extracted percent daily value as in the example below:

For example, the following string may be extracted for sodium:

“Sodium 15 mg 2%”

From this string, the system can extract 15 for nutrition value and 2% for the percent daily value. The recommended daily value for sodium is 2,400, which means that the extracted value corresponds to “15/2400=0.00626˜=1%” which is different from the 2%. In this example, the correct extracted nutrition value was actually “55” but the OCR transcription incorrectly read the “5”. It is difficult to know, a priori, whether it is the nutrition value or the percent daily value is the cause of the error. Thus, in this situation this item may be flagged for review by the QA team (human review pipeline), which can correct it. This correction can be recorded, and if it is a common mistake, a rule may be created to be applied to resolve future errors or when a confidence score fails to meet a given threshold.

Nutrition chart read errors may be exacerbated by the shape of the product. For example, it is more likely to make mistakes on the edges of a nutrition chart wrapping around a cylindrical container such as a soup can, especially if that nutrition chart is of a horizontal style. The system can account for this by first identifying the container type, e.g. “cylindrical can” and the nutrition chart type “horizontal-column style” and then, if we have previously seen many errors associated with this combination, the image will be flagged for review by the human review pipeline.

Further, the OCR may fail to pull the value entirely or the required nutrition item string is not recognizable enough to correctly associate the extracted value with the correct nutrition item (e.g. “o1al 4at”=>“Total Fat”). To help with omission of information, the system may identify different types of nutrition charts with varying information. For example, all nutrition charts contain information such as calories, protein, serving size, cholesterol, sodium, total fat, and total carbohydrates. Thus, if the system has found some of these items but not all, it can flag the data for review by the human review pipeline. Likewise, even though some nutrition items are not always present, they are often co-occurring. For example, if “Vitamin A” is present, likely so is “Vitamin C”. Thus, the system can implement a rule stating that, if it has identified “Vitamin A” but “Vitamin C” is missing, it can flag the item for review.

While example embodiments have been particularly shown and described, it will be understood by those skilled in the art that various changes in form and details may be made therein without departing from the scope of the embodiments encompassed by the appended claims.

What is claimed is:

1. A computer-implemented method of populating a database with product information, the method comprising:
identifying candidate product information within an image of product packaging of a product;
applying a model created by machine learning to the candidate product information to discern indicators of product attributes from indicators of non-product attributes of the candidate product information;
extracting individual indicators from the indicators of product attributes;
in response to a determination that additional confidence is needed for a given individual indicator, applying a rule to identify unique product information from the given individual indicator;
applying a taxonomy to the product attributes based on the individual indicators to generate categorized product attributes representing the product; and
populating a database with the categorized product attributes.

2. The method of claim 1, further comprising:
comparing the given individual indicator against a list of names of known brands and products; and
associating the given individual indicator with a matching one of the names of known brands and products in response to detecting a match.

3. The method of claim 2, further comprising, in response to failing to detect a match between the individual indicator and the known brands and products:
dividing the given individual indicator into sub-word units;
applying the sub-word units to a natural-language processing (NLP) unit to determine a candidate match and a confidence score, the candidate match being one of the list of known brands and products; and
associating the given individual indicator with the candidate match in response to the confidence score being above a given threshold.

4. The method of claim 1, further comprising:
identifying an entry representing the product in an external database; and
mapping the categorized product attributes to corresponding product information stored at the entry.

5. The method of claim 4, further comprising updating the categorized product attributes based on a detected difference from the entry.

6. The method of claim 1, further comprising:
searching an external database for information associated with the product based on the product attributes; and
updating the database based on the information associated with the product.

7. The method of claim 1, further comprising:
determining derived product attributes based on at least one of the product attributes, the derived product attributes being absent from the candidate product information; and
populating the database with representations of the derived product attributes.

8. The method of claim 1, further comprising;
generating a map relating the categorized product attributes to corresponding product information stored at an external database; and
updating a format of the map based on a format associated with the external database.

9. The method according to claim 1, further comprising determining a product type from characteristics of the product packaging.

10. The method of claim 9, wherein the characteristics of the product packaging include size or shape.

11. The method according to claim 1, further comprising preprocessing the image of product packaging by adjusting lighting or other aspects of the image.

12. The method according to claim 1, wherein extracting the individual indicators includes extracting auxiliary information about the product that is a pseudo-attribute of the product.

13. The method of claim 12, wherein the auxiliary information about the product is contextual information about product relevant to a consumer of the product, and wherein the pseudo-attribute of the product is selected from a list including at least one of the following: source of the product or packaging, environmental considerations relating to the product or packaging, associations of the product or packaging with a social cause.

14. The method according to claim 1, further comprising training the model created by machine learning by identifying relevance of the product attributes by a human and inputting that information into a neural network or convolution neural network.

15. The method according to claim 1, further comprising applying optical character recognition to the individual indicator, and wherein applying the rule includes applying natural language processing.

16. The method according to claim 1, further comprising forwarding the product attributes in a prescribed order to a distal database.

17. The method according to claim 1, further comprising performing optical image processing on an image of a product from a requesting client and responsively returning the discrete items of data in a prescribed order to the requesting client in less than 10 minutes from a time of receipt of the image.

18. The method according to claim 1, wherein, after extracting the individual indicators, applying at least one rule to an individual indicator having a confidence level of below 96% until the confidence level is improved to a confidence level above 96%.

19. The method according to claim 1 wherein applying the rule includes applying a rule that identifies the individual indicator for evaluation by a reviewer, and further comprising updating the database based on an input by the reviewer.

20. A computer-implemented method of enabling storage of product information in a database, the method comprising:
applying a model created by machine learning to candidate product information within a digital representation of product packaging to discern indicators of product attributes on the packaging from indicators of non-product attributes; and
processing representations of the product attributes to enable storage of the representations in corresponding fields of a database.

21. The computer-implemented method of claim 20 further comprising identifying indicia of the candidate product information as a function of size, shape, or combination thereof of the product packaging.

22. The computer-implemented method of claim 20 further comprising applying a rule to identify the candidate product information.

23. The computer-implemented method of claim 20 wherein processing representations of the product attributes includes arranging the representations in an order consistent with corresponding fields of a database or with metadata labels that enable the database to store the corresponding representations in corresponding fields.

24. A computer-implemented method of auditing stored product information in a database, the method comprising:
retrieving product information from a database;
applying a model created by machine learning to candidate product information within a digital representation of product packaging to discern indicators of product attributes on the packaging from indicators of non-product attributes;
processing representations of the product attributes to enable storage of the representations in corresponding fields of a database; and
auditing the product information retrieved from the database by comparing the product information with corresponding representations of the product information gleaned by applying the model to the candidate product information.

25. A system for determining product information, the system comprising:
an image scanner configured to identify candidate product information within an image of product packaging of a product;
a data processor configured to:
apply a model created by machine learning to the candidate product information to discern indicators of product attributes from indicators of non-product attributes of the candidate product information;
extract individual indicators from the indicators of product attributes;
in response to a determination that additional confidence is needed for a given individual indicator, apply a rule to identify unique product information from the given individual indicator;
apply a taxonomy to the product attributes based on the individual indicators to generate categorized product attributes representing the product; and
a database configured to store the categorized product attributes.
